(19) United States
(12) Patent Application Publication
(10) Pub. No.: US 2026/0178529 A1
(43) Pub. Date: Jun. 25, 2026

(54) SMART RETIMER DEVICE

(71) Applicant: Advanced Micro Devices, Inc., Santa Clara, CA (US)

(72) Inventors: Mahesh UdayKumar Wagh, Austin, TX (US); Nitish Paliwal, Austin, TX (US)

(73) Assignee: Advanced Micro Devices, Inc., Santa Clara, CA (US)

(21) Appl. No.: 18/990,607

(22) Filed: Dec. 20, 2024

(51) Int. Cl. G06F 13/40

(52) U.S. Cl. CPC G06F 13/4054; G06F 13/4059

(57) ABSTRACT

The disclosed device provides smart retimer features for a bus that is compatible with slower speed devices, such as devices using an older generation protocol for the bus. The smart retimer device can convert data packets into different formats and utilize available lanes for more efficient use of available bandwidth. Various other methods, systems, and computer-readable media are also disclosed.

### BACKGROUND

A retimer is a signal extension device that allows longer physical channels (e.g., extending a physical length of a link) for sending data between components. Rather than amplifying a data signal, a retimer can retransmit a fresh copy of the data signal and therefore can be aware of (e.g., actively participate in) a physical layer protocol, such as PCIe®. In some implementations, a retimer can recover a data stream and retransmit it on a clean clock, enabling an extension of the channel to twice the original protocol specification.

As computing devices, such as server systems, scale across increasing computing requirements (including memory bandwidth and capacity), a corresponding increase in IO performance can be needed. IO buses (e.g., PCIe) often increase data rates with newer generations. However, even if a host device and bus (e.g., having a retimer) is capable of the increased data rate, endpoint devices/peripherals can be slower (e.g., from a prior generation), such that the increased data rate can be underutilized.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for a smart retimer device.

FIG. 2 is a block diagram of an example scale-out of a smart retimer device.

FIGS. 3A-C are block diagrams of example lane mappings for a smart retimer device.

FIGS. 4A-B are block diagrams of example downstream and upstream configurations for a smart retimer device.

FIG. 5 is a flow diagram of an example method for a signal extension device such as a smart retimer device.

FIG. 6 is a flow diagram of another example method for a signal extension device.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a signal extension device for a peripheral interface, such as a retimer device. As will be explained in greater detail below, implementations of the present disclosure include a first plurality of data lanes configured to transmit data at a first data rate, and a second plurality of data lanes configured to transmit data at a second data rate that is less than the first data rate. The retimer can include a control circuit configured to retransmit data between the first plurality of data lanes and the second plurality of data lanes in accordance with a static mapping of lanes. In addition, the control circuit can be configured to convert data between a first data packet format corresponding to the first plurality of data lanes and a second data packet format corresponding to the second plurality of data lanes. The retimer can forego routing features between the data lanes to advantageously provide a simplified signal extension device that can provide compatibility between host devices supporting a newer generation of an interface protocol with endpoint devices of older generations of the interface protocol, and further allows efficient utilization of available bandwidth therebetween. The systems and methods provided herein can improve the functioning of a computing device itself by taking advantage of surplus bandwidth when connecting with devices of the older generations of the interface protocol, and further provides a simplified retimer device having a smaller footprint and more efficient power consumption than that of an interface switch device. In addition, the systems and methods provided herein improve the technical field of device interface by providing added functionality to newer generations of the interface protocol.

Features from any of the implementations described herein can be used in combination with one another in accordance with the general principles described herein. These and other implementations, features, and advantages will be more fully understood upon reading the following detailed description in conjunction with the accompanying drawings and claims.

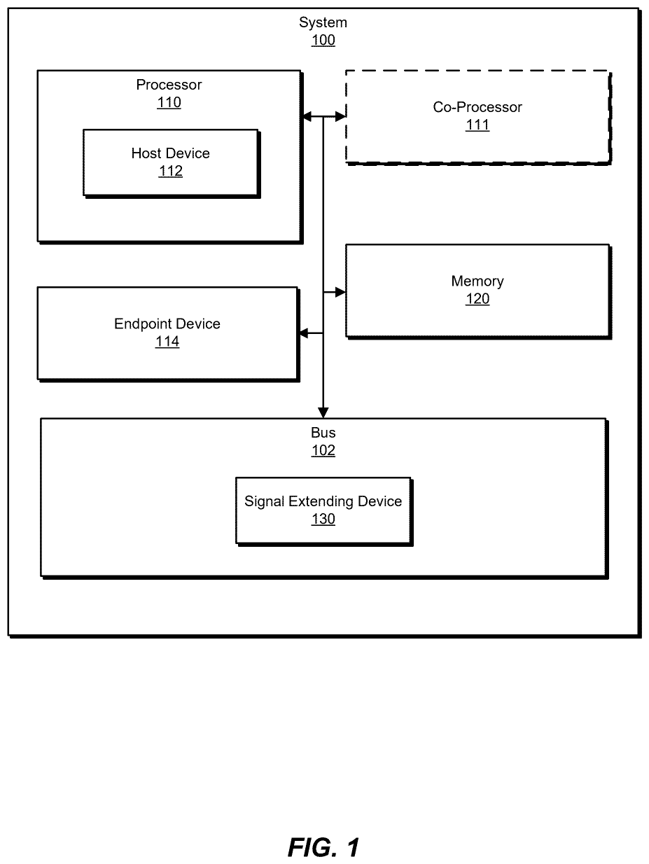

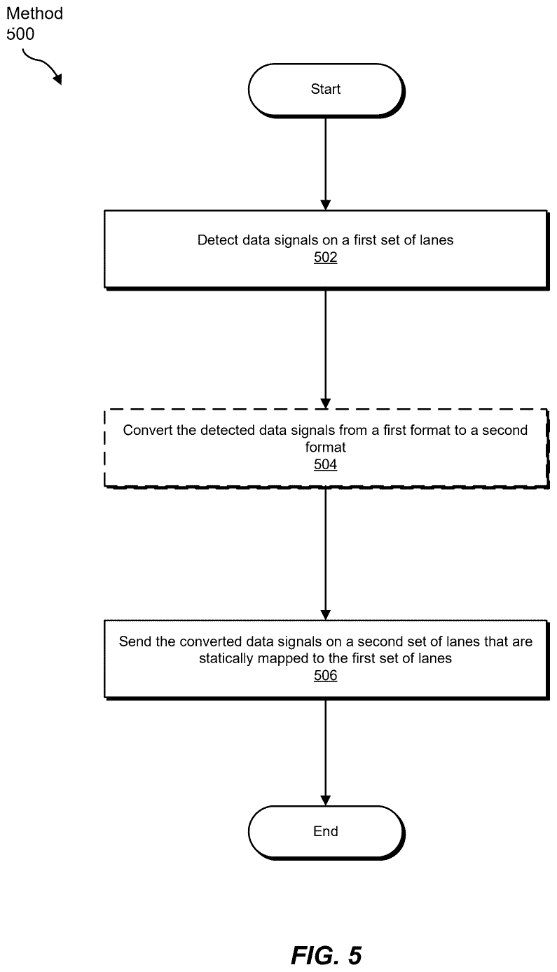

The following will provide, with reference to FIGS. 1-5, detailed descriptions of a smart retimer device. Detailed descriptions of example systems and architectures will be provided in connection with FIGS. 1, 2, 3A-3C, and 4A-4B. Detailed descriptions of corresponding computer-implemented methods will also be provided in connection with FIG. 5.

FIG. 1 is a block diagram of an example system 100 for a signal extension device such as a smart retimer device. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

As further illustrated in FIG. 1, processor 110 includes host device 112, system 100 includes an endpoint device 114, and bus 102 includes a signal extending device 130. Host device 112 generally represents any processing circuit that communicates with endpoint device 114 via bus 102. Host device 112 can correspond to a component (e.g., logic/arithmetic unit) of processor 110 (and/or co-processor 111) and can correspond to processor 110 (and/or co-processor 111) itself. Endpoint device 114 generally represents any circuit that communicates with host device 112 via bus 102. Endpoint device 114 can correspond to a processing circuit and/or component thereof (e.g., in some examples corresponding to co-processor 111), a memory device (e.g., in some example corresponding to memory 120), a peripheral device (e.g., any other computing component and/or circuit which can communicate with and/or otherwise interface with system 100 and/or components therein via bus 102). Signal extending device 130 generally represents any circuit that can provide a physical channel for sending data signals across at least a portion of a link between circuits connected via bus 102 (e.g., between host device 112 and endpoint device 114). As will be described further below, in some implementations signal extending device 130 can be a smart retimer device.

In some examples, bus 102 can correspond to an interface, such as an IO interface that supports a first interface protocol. Host device 112 can also be configured to support the first interface protocol. For example, host device 112 can send/receive data that can be transmitted through bus 102 with data signals sent using a first data packet format in conformance with the first interface protocol. In one example, the first interface protocol can be PCIe 6.0 and the first data packet format can be Flow Control Unit (FLIT) encoding. In some examples, FLIT encoding can used packets of a fixed size to encapsulate other types of packets (e.g., Transaction Layer Packet (TLP) and/or Data Link Layer Packet (DLLP)) that can have variable sized packets. The first interface protocol can further define a number of supported data lanes (also referred to as “lanes” herein) and bandwidth and/or data transfer rates thereof. A data lane or lane generally represent to a data channel providing a pathway for transmitting and receiving data between two components (e.g., host device 112 and endpoint device 114) and can refer to a differential signal pair (e.g., transmit and receive) that can be physically implemented with multiple wires and/or traces as well as other signal connecting circuits/devices.

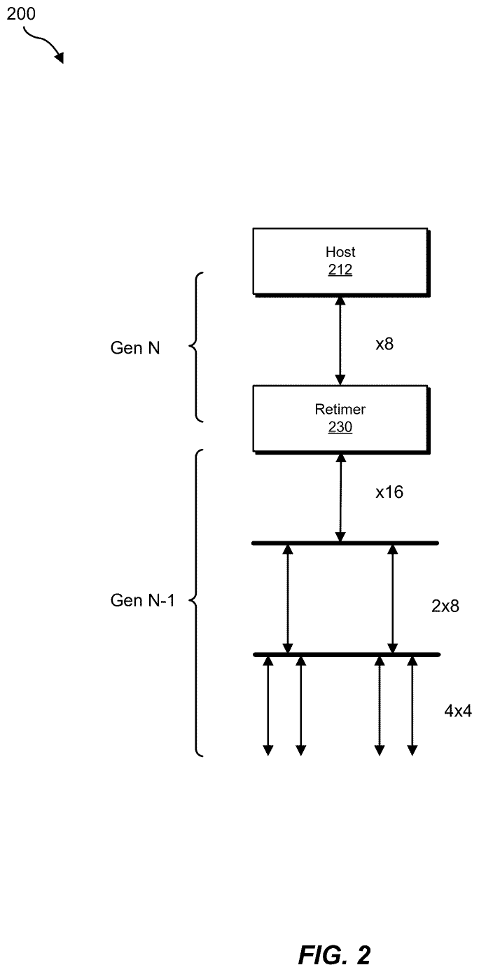

In some examples, endpoint device 112 can be configured for to support a second interface protocol that can be different from the first interface protocol, such as by defining a different number of lanes, bandwidth/data transfer rates, and/or data packet format. In one example, the second interface protocol can be PCIe 5.0 using TLP and/or DLLP formats for transmitting data. Although the examples herein describe different generations (e.g., the newer 6.0 generation and the older 5.0 generation of PCIe) of a general interface protocol, in other examples, the first and second interface protocols can refer to different protocols. Signal extending device 130 can allow host device 112 to communicate with endpoint device 114 by facilitating an interface between the first interface protocol and the second interface protocol, as illustrated in FIG. 2.

FIG. 2 illustrates a fanout diagram 200 of a host 212 (corresponding to host device 112) and a retimer 230 (corresponding to signal extending device 130). In FIG. 2, the first interface protocol can represent a current generation or a specific generation of the interface protocol (e.g., indicated as “Gen N”) and the second interface protocol can represent a prior generation of the interface protocol (e.g., as indicated as “Gen N−1” although can represent any prior generation such as N−2, etc.). In some examples, host 212 can be configured for the first interface protocol and have 8 lanes (indicated by “x8”) with retimer 230. In FIG. 2, the data rate of the first interface protocol can be twice the data rate of the second interface protocol (e.g., having a 2:1 ratio although in other examples other ratios can be used). Based on this ratio of data rates, the lanes of the first interface protocol (e.g., x8) can correspond to twice the lanes of the second interface protocol (e.g., x16) as illustrated in FIG. 2 such that retimer 230 can utilize the x8 lanes of the first interface protocol as x16 lanes of the second interface protocol. Retimer 230 can further allow different arrangements of lanes, such as x8 lanes for two different endpoint devices (e.g., 2×8), x4 lanes for four different endpoint devices (e.g., 4×4). In yet other examples, other arrangements can be used as available based on the ratio of data rates, including having unequal distribution of lanes across endpoint devices (e.g., 2×4 and 1×8, etc.).

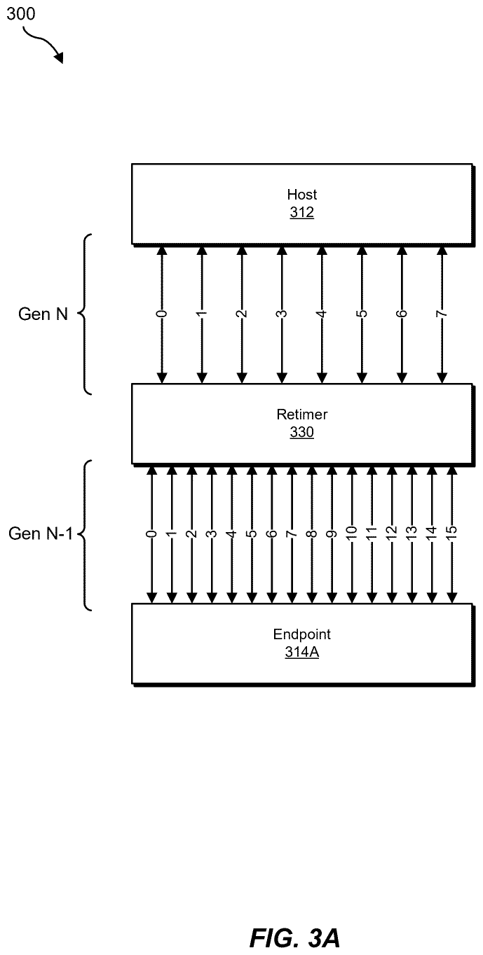

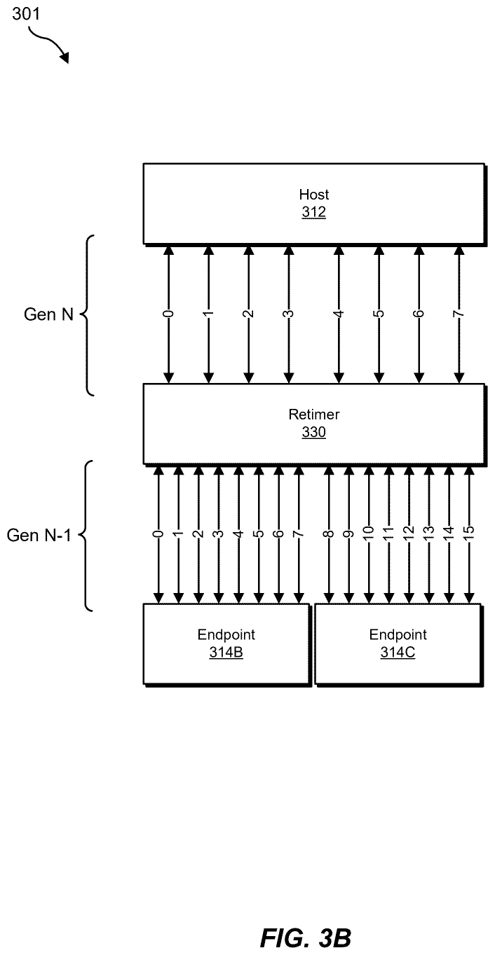

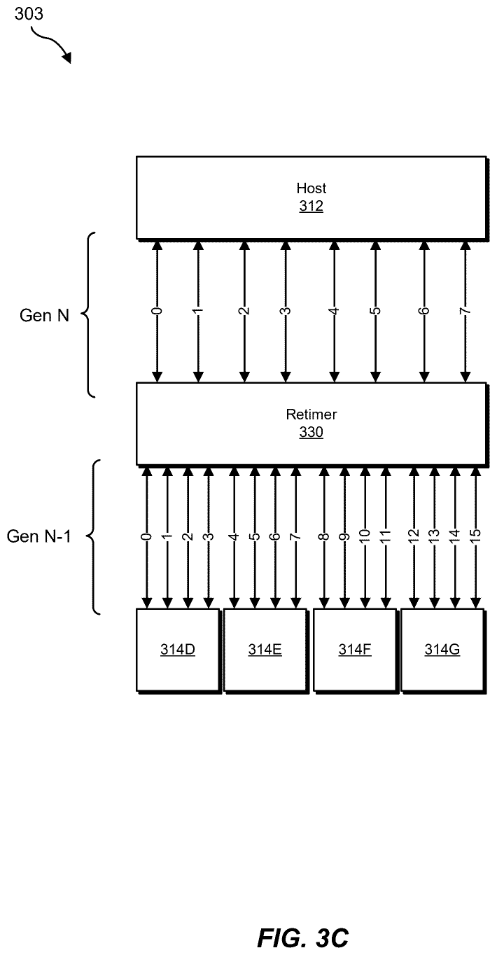

FIGS. 3A-3C illustrate example lane mappings of the example fanouts depicted in FIG. 2. Similar to FIG. 2, in FIGS. 3A-3C the first interface protocol can represent a current generation or a specific generation of the interface protocol (e.g., indicated as “Gen N”) and the second interface protocol can represent a prior generation of the interface protocol (e.g., as indicated as “Gen N−1” although can represent any prior generation such as N−2, etc.). For instance, FIG. 3A illustrates a mapping 300 of an x16 example, FIG. 3B illustrates a mapping 301 of a 2×8 example, and FIG. 3C illustrates a mapping 303 of a 4×4 example. FIGS. 3A-3C illustrate a host 312 (corresponding to host device 112) and a retimer 330 (corresponding to signal extending device 130). For instance, host 312 can have 8 lanes (e.g., x8) that can be indexed from 0-7 as illustrated. With the data rate of each lane in the first interface protocol being double that of the data rate of the second interface protocol, each lane of the first interface protocol can provide the bandwidth of two lanes of the second interface protocol such that retimer 330 can map each lane of the first interface protocol into two lanes of the second interface protocol (indexed as 0-15 in FIGS. 3A-3C). In other words, retimer 330 can have a first number of lanes of the first interface protocol and a second number of lanes of the second interface protocol, with the first number relates to the second number based on the ratio of data rates (e.g., an inverse of the ratio of data rates).

In some implementations, the mappings can be a static mapping, which can reduce complexity and overhead compared to a dynamic mapping. For example, the static mapping can be a one-to-many mapping (e.g., based on the ratio of data rates such at a lane of the first interface protocol can be mapped to multiple lanes of the second interface protocol based on equivalent bandwidth). In FIGS. 3A-3C, each lane of the first interface protocol can be mapped to two lanes of the second interface protocol, for instance lane 0 of the first interface protocol (e.g., between host 312 and retimer 330) being mapped to lane 0 and lane 1 of the second interface protocol (e.g., between retimer 330 and appropriate endpoint device), lane 1 being mapped to lane 2 and lane 3, lane 2 being mapped to lane 4 and lane 5, and so forth.

In FIG. 3A, an endpoint 314A (corresponding to a separate iteration of endpoint device 114) can be configured for the second interface protocol with 16 lanes (x16) such that endpoint 314A can be connected to lanes 0-15 of the second interface protocol. Accordingly, lanes 0-7 of the first interface protocol are connected to endpoint 314A via retimer 330.

In. FIG. 3B, an endpoint 314B and an endpoint 314C (each corresponding to separate iterations of endpoint device 114) can each be configured for the second interface protocol with 8 lanes (x8). Accordingly, lanes 0-3 of the first interface protocol can be mapped to lanes 0-7 of the second interface protocol and connect to endpoint 314B, and lanes 4-7 of the first interface protocol can be mapped to lanes 8-15 of the second interface protocol and connect to endpoint 314C.

In. FIG. 3C, an endpoint 314D, an endpoint 314E, an endpoint 314F, and an endpoint 314G (each corresponding to separate iterations of endpoint device 114) can each be configured for the second interface protocol with 4 lanes (x4). Accordingly, lanes 0-1 of the first interface protocol can be mapped to lanes 0-3 of the second interface protocol and connect to endpoint 314D, lanes 2-3 of the first interface protocol can be mapped to lanes 4-7 of the second interface protocol and connect to endpoint 314E, lanes 4-5 of the first interface protocol can be mapped to lanes 8-11 of the second interface protocol and connect to endpoint 314F, and lanes 6-7 of the first interface protocol can be mapped to lanes 12-15 of the second interface protocol and connect to endpoint 314G.

As illustrated in FIGS. 3A-3C, the lanes can be statically mapped (e.g., lane 0 on the host side mapped to lanes 0 and 1 on the endpoint side) in a one-to-many based on a ratio of bandwidth (e.g., the host side lanes having double the bandwidth of the endpoint side lanes such that each host side lane is mapped to two endpoint side lanes). FIGS. 3A-3C further illustrate that the physical lanes are statically mapped, although the endpoint side lanes can connect to different endpoint devices while maintaining the static mapping. For example, lane 4 on the host side can be mapped to lane 8 and lane 9 on the endpoint side although in different examples, lanes 8 and 9 can be connected to different endpoint devices supporting different number of lanes (e.g., endpoint 314A in FIG. 3A, endpoint 314C in FIG. 3B, and endpoint 314F in FIG. 3C). In some examples, such static mapping reduces any overhead incurred for dynamic mapping.

Moreover, although FIGS. 3A-3C illustrate host 312 coupled to endpoints 314A-G, in other examples intervening components can be connected, such that retimer 330 can be indirectly connected to host 312 and endpoints 314A-G. In some examples, one or more switch devices can be connected therebetween (e.g., connected to the various lanes described). In addition or alternatively, host 312 and/or any of endpoints 314A-G can correspond to a switch or other device. For instance, any of endpoints 314A-G can correspond to a switch device or other lower speed device that may require data rate change (e.g., from host 312) and/or data packet format conversion.

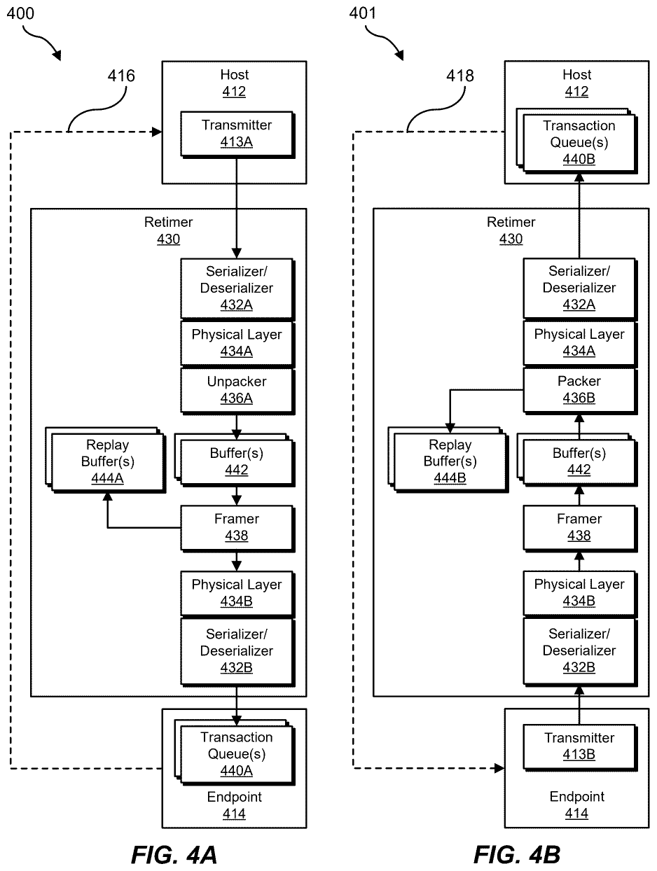

FIGS. 4A-4B illustrate an example architecture including a host 412 (corresponding to a host device 112), a retimer 430 (corresponding to signal extending device 130), and an endpoint 414 (corresponding to endpoint device 114). As illustrated in FIGS. 4A-4B, retimer 430 can include one or more control circuits (e.g., for converting data between the first interface protocol and the second interface protocol) and/or other components (e.g., for connecting the statically mapped lanes as described herein). FIGS. 4A-4B correspond to an example implementation that includes components/logic to support data packet format conversion (e.g., between FLIT and non-FLIT packets) which in some examples may be unused and/or not included (e.g., when conversion between FLIT and no-FLIT packets is not required).

In some implementations, retimer 430 can includes a serializer/deserializer 432A, a physical layer 434A, an unpacker 436A, a packer 436B, one or more buffers 442, one or more replay buffers 444A, one or more replay buffers 444B, a framer 438, a physical layer 434B, and a serializer/deserializer 432B. In some examples, a serializer/deserializer (SerDes) can generally refer to one or more circuits (e.g., a pair of functional blocks/circuits) for converting data between serial data and parallel interfaces, for example receiving data in parallel (e.g., bits from multiple pins/interconnects) and outputting in serial (e.g., as a stream of bits), and/or receiving data in serial and outputting in parallel. A physical layer can generally refer to a transmission medium (e.g., an electrical, mechanical and/or procedural interface) for transmitting data signals (e.g., raw bits). A packer can generally refer to one or more circuits for encapsulating data into a packet format. An unpacker can generally refer to one or more circuits for extracting data that has been encapsulated in a packet format. In FIGS. 4A-4B, unpacker 436A and/or packer 436B can correspond to a FLIT packing scheme in the Data Link Layer (e.g., a FLIT unpacker and a FLIT packer, respectively), although in other implementations can correspond to other packing schemes. A framer can generally refer to one or more circuits for indicating (e.g., via special symbols) a start and/or an end of a packet in a packet format. In some examples, a control circuit of retimer 430 can include, represent, and/or otherwise interface with one or more of serializer/deserializer 432A, physical layer 434A, unpacker 436A, packer 436B, buffer(s) 442, replay buffer(s) 444A, replay buffer(s) 444B, a framer 438, physical layer 434B, and/or serializer/deserializer 432B. In addition, retimer 430 can include multiple lanes that can be statically mapped (see, e.g., FIGS. 3A-3C) between host side lanes (e.g., connecting host 412 to retimer 430 and/or physical layer 434A) and endpoint side lanes (e.g., connecting endpoint 414 to retimer 430 and/or physical layer 434B) although not explicitly shown in FIGS. 4A-4B.

FIG. 4A illustrates a downstream transmission 400 for host 412 transmitting data to endpoint 414 via retimer 430. A transmitter 413A can correspond to a circuit, functional block, and/or other component of host 412 producing data to be transmitted. One or more transaction queues 440A can correspond to one or more queues (e.g., buffers and/or other circuits for holding data) for one or more classes of transactions/data transmissions (e.g., posted header, posted data, non-posted header, non-posted data, completion header, completion data).

In FIG. 4A, retimer 430 can receive a data stream from transmitter 413A (e.g., via one or more lanes coupled to physical layer 434A) in a first data packet format corresponding to the first interface protocol. For example, the first data packet format can be a FLIT format as described herein. Retimer 430 can convert the received data stream into a second data packet format. For example, serializer/deserializer 432A can convert data signals received on multiple lanes (e.g., in parallel) into a serial data stream that can be unpacked by unpacker 436A (e.g., extracting data/payload from the FLITs, which in some examples can correspond to TLP/DLLP packets that have been encapsulated). The unpacked data can be stored in one or more buffers, such as buffer(s) 442 which can correspond to store-and-forward shallow buffers that can temporarily hold the converted data stream until ready for processing by framer 438.

In some examples, the unpacked data can require further processing for conversion into a second packet format (e.g., TLP/DLLP) for the second interface protocol. For example, TLP/DLLP packets can be previously encapsulated into FLITs. Because the packet sizes of TLP/DLLP packets and FLITs can differ, a TLP/DLLP packet can in some instances be broken into multiple portions across multiple FLITs. In other instances, a FLIT can include an entirety of a first TLP/DLLP packet (e.g., if smaller than a payload size of the FLIT), and a portion of a second TLP/DLLP packet (e.g., using a remaining available space of the payload of the FLIT). In yet further examples, TLP/DLLP packets can be out of order when encapsulated in FLITs. Accordingly, in some examples, framer 438 can reassemble packets of the second interface protocol, and transmit the converted data stream from buffer(s) 442 to endpoint 414 and/or transaction queue(s) 440A as appropriate (e.g., using serializer/deserializer 432B to convert the data stream into a parallel output for transmitting in parallel through one or more lanes coupled to physical layer 434B).

In some examples, framer 438 can also store the converted data stream (e.g., TLP/DLLP packets) into replay buffer(s) 444A to allow replay (e.g., a retransmitting of a previously transmitted data signal in response to a replay request or lack of an acknowledgment for receiving the previously transmitted data signal). In some instances, framer 438 can receive a replay request (e.g., from endpoint 414) to send a particular packet (e.g., TLP/DLLP packet) that could have been dropped, unreadable, etc. In some examples, framer 438 can deallocate a packet from replay buffer(s) 444A in response to an acknowledgement response from endpoint 414 (e.g., as received through the one or more lanes coupled to physical layer 434B).

Moreover, in some examples, retimer 430 can detect an error in the received data stream (e.g., detected by unpacker 436A and/or framer 438), and discard the received data stream in response to detecting the error.

A credit transmission 416 represents endpoint 414 passing through transmit flow control information to host 412, bypassing any transmit flow control management from retimer 430. In other words, retimer 430 can transmit any credit information without altering or otherwise managing transmit flow control. In some examples, transmit flow control can refer to a protocol for managing transmissions, such as using credits/tokens that can represent an amount of transmissions (e.g., each credit/token representing a single transmission) that are available (e.g., representing a buffer space available in the relevant sender/receiver). For example, an initial number of credits can correspond to a number of transmissions that endpoint 414 can receive. For each transmission that endpoint 414 receives, the number of credits can be decremented (by one), and as endpoint 414 processes a received transmission (e.g., clearing space in the relevant buffer), the number of credits can be incremented (by one). In some implementations, to reduce a complexity of retimer 430 as well as improve efficiency and provide faster performance, retimer 430 can avoid any managing of the transmit flow control information, for instance by passing through the credit information (e.g., number of credits/tokens) without modification. As such, endpoint 414 can send credit transmission 416 as if directly sent between endpoint 414 and host 412, and further in some implementations credit transmission 416 can be sent separately (e.g., physically bypassing retimer 430).

FIG. 4B illustrates an upstream transmission 401 for endpoint 414 transmitting data to host 412 retimer 430. A transmitter 413B can correspond to a circuit, functional block, and/or other component of endpoint 414 producing data to be transmitted. One or more transaction queues 440B can correspond to one or more queues (e.g., buffers and/or other circuits for holding data) for one or more classes of transactions/data transmissions as described herein.

The examples of FIG. 4A described above can represent examples including conversion of data packet format (e.g., from FLIT packets to non-FLIT packets). In some examples, in which such conversion is not required or otherwise used, certain components and/or logic may be omitted. For example, the replay logic/components described herein (e.g., replay buffer(s) 444A, replay request, etc.) can be optional if data packet format conversion is not needed. Other components/logic, such as unpacker 436A, framer 438, and/or functionality thereof, can be modified to support retransmitting data packets without data packet format conversion.

In FIG. 4B, retimer 430 can receive a data stream from transmitter 413B (e.g., via one or more lanes coupled to physical layer 434B) in the second data packet format corresponding to the second interface protocol. For example, the second data packet format can be a TLP/DLLP format as described herein. Retimer 430 can convert the received data stream into the first data packet format. For example, serializer/deserializer 432B can convert data signals received on multiple lanes (e.g., in parallel) into a serial data stream that can be parsed into packets by framer 438 (e.g., identifying starts/ends to packets that may be variable sized). The packets can be stored in one or more buffers 442 (e.g., store-and-forward shallow buffers that can temporarily hold the packets until ready for processing by packer 436B).

In some examples, the packets can require further processing for conversion into the first packet format (e.g., FLIT) for the first interface protocol. For example, the TLP/DLLP packets can encapsulated into FLITs. As described herein, this encapsulating can include breaking variable-sized packets into portions for arranging into uniform-sized (payload) space of FLITs, for instance filling any available space of a given FLIT with a portions of one or more TLP/DLLP packets, which in some examples can further include rearranging an order of the packets (e.g., such that portions of non-consecutive packets can be arranged into a FLIT payload and/or spread across non-consecutive FLITs). Accordingly, in some examples, packer 436B can encapsulate the TLP/DLLP packets into FLITs, and transmit the converted data stream from buffer(s) 442 to host 412 and/or transaction queue(s) 440B as appropriate (e.g., using serializer/deserializer 432A to convert the data stream into a parallel output for transmitting in parallel through one or more lanes coupled to physical layer 434A).

In some examples, packer 436B can store the converted data stream (e.g., FLITs) into replay buffer(s) 444B to allow replay. In some instances, packer 436B can receive a replay request (e.g., from host 412) to send a particular packet (e.g., FLIT) that could have been dropped, unreadable, etc. In some examples, packer 436B can deallocate a packet from replay buffer(s) 444A in response to an acknowledgement response from host 412 (e.g., as received through the one or more lanes coupled to physical layer 434A).

Moreover, in some examples, retimer 430 can detect an error in the received data stream (e.g., detected by framer 438 and/or packer 436B), and discard the received data stream in response to detecting the error.

FIG. 4B further illustrates a credit transmission 418 that represents host 412 passing through flow control information to endpoint 414, bypassing any transmit flow control management from retimer 430. In other words (similar to credit transmission 416 for downstream transmissions), retimer 430 can transmit any credit information for upstream transmissions without altering or otherwise managing transmit flow control. For example, as host 412 processes a received transmission (e.g., clearing space in the relevant buffer), host 412 can send updated credit information (e.g., number of credits/tokens) via credit transmission 418 as if directly sent between host 412 and endpoint 414, and further in some implementations credit transmission 418 can be sent separately (e.g., physically bypassing retimer 430).

FIG. 5 is a flow diagram of an exemplary computer-implemented method 500 for efficient data transmission with a smart retimer device. The steps shown in FIG. 5 can be performed by any suitable device and/or computing system, including the system(s) illustrated in FIGS. 1, 2, 3A-3, and/or 4A-4B. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein detect data signals on a first set of lanes. For example, in a downstream transmission, retimer 430 can detect data sent from host 412. In reference to FIGS. 3A-3C, depending on the endpoint device(s) connected/receiving, retimer 330 can receive data from lanes 0-7 (in FIG. 3A having endpoint 314A as the receiver), from lanes 0-3 and/or lanes 4-7 (in FIG. 3B having endpoint 314B and/or endpoint 314C as the receiver(s)), or from lanes 0-1, lanes 2-3, lanes 4-5, and/or lanes 6-7 (in FIG. 3C having endpoint 314D, endpoint 314E, endpoint 314F, and/or endpoint 314G as the receiver(s)). In an upstream transmission example, retimer 430 can detect data sent from endpoint 414. In reference to FIGS. 3A-3C, depending on the endpoint device(s) connected/transmitting, retimer 330 can receive data from lanes 0-15 (in FIG. 3A having endpoint 314A as the sender), from lanes 0-7 and/or lanes 8-15 (in FIG. 3B having endpoint 314B and/or endpoint 314C as the sender(s)), or from lanes 0-3, lanes 4-7, lanes 8-11, and/or lanes 12-15 (in FIG. 3C having endpoint 314D, endpoint 314E, endpoint 314F, and/or endpoint 314G as the sender(s)).

At step 504 one or more of the systems described herein optionally convert the detected data signals from a first format to a second format. In the downstream transmission example, retimer 430 can convert data from a FLIT format (e.g., as sent/supported by host 412) to a TLP and/or DLLP format (e.g., as supported by endpoint 414) as described herein. In the upstream transmission example, retimer 430 can convert data from the TLP and/or DLLP format (e.g., as sent/supported by endpoint 414) to the FLIT format (e.g., as supported by host 412) as described herein.

At step 506 one or more of the systems described herein send the converted data signals on a second set of lanes that are statically mapped to the first set of lanes. In reference to FIGS. 3A-3C, depending on the endpoint device(s) connected/receiving, retimer 330 can send data on lanes 0-15 (in FIG. 3A having endpoint 314A as the receiver), on lanes 0-7 and/or lanes 8-15 (in FIG. 3B having endpoint 314B and/or endpoint 314C as the receiver(s)), or on lanes 0-3, lanes 4-7, lanes 8-11, and/or lanes 12-15 (in FIG. 3C having endpoint 314D, endpoint 314E, endpoint 314F, and/or endpoint 314G as the receivers(s)). In the downstream example, retimer 430 can send TLP and/or DLLP packets to endpoint 414. In the upstream example, retimer 430 can send FLITs to host 412. In reference to FIGS. 3A-3C, depending on the endpoint device(s) connected/sender, retimer 330 can send on lanes 0-7 (in FIG. 3A having endpoint 314A as the sender), on lanes 0-3 and/or lanes 4-7 (in FIG. 3B having endpoint 314B and/or endpoint 314C as the sender(s)), or on lanes 0-1, lanes 2-3, lanes 4-5, and/or lanes 6-7 (in FIG. 3C having endpoint 314D, endpoint 314E, endpoint 314F, and/or endpoint 314G as the sender(s)).

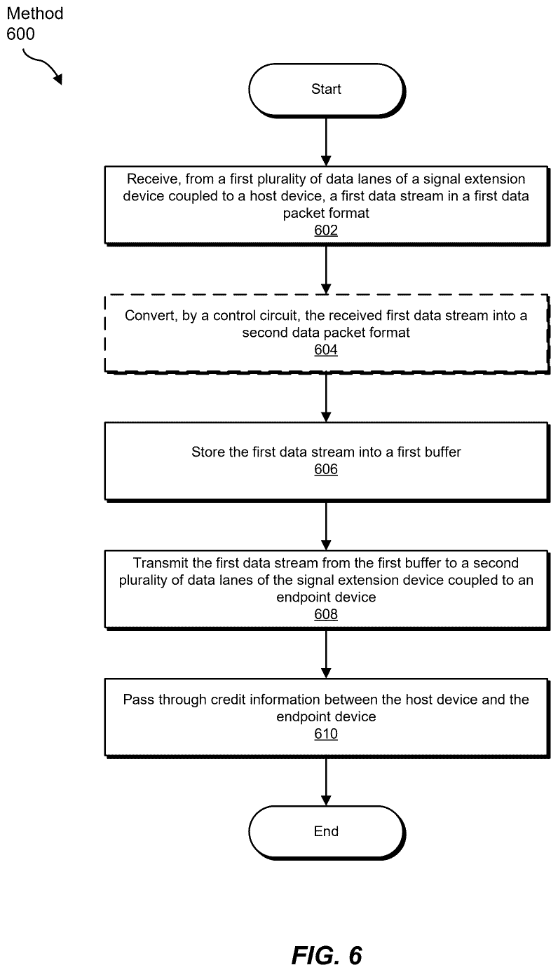

FIG. 6 is a flow diagram of an exemplary computer-implemented method 600 for efficient data transmission with a signal extension device. The steps shown in FIG. 6 can be performed by any suitable computer-executable code and/or computing system, including the system(s) illustrated in FIGS. 1, 2, 3A-3, and/or 4A-4B. In one example, each of the steps shown in FIG. 6 represent an algorithm whose structure includes and/or is represented by multiple sub-steps, examples of which will be provided in greater detail below.

As illustrated in FIG. 6, at step 602 one or more of the systems described herein receive, from a first plurality of data lanes of a signal extension device coupled to a host device, a first data stream in a first data packet format. For example, signal extending device 130 can receive a first data stream in a first data packet format.

The systems described herein can perform step 602 in a variety of ways. In one example, the first plurality of data lanes is coupled to host device 112 and configured to transmit data at a first data rate.

At step 604 one or more of the systems described herein optionally convert, by a control circuit, the received first data stream into a second data packet format. For example, signal extending device 130 (and/or a control circuit thereof as described herein) can convert the first data stream into a second data packet format.

At step 606 one or more of the systems described herein store the first data stream into a first buffer, which can be the converted first data stream if converted at step 604. For example, signal extending device 130 can store the first data stream in a buffer (e.g., buffer(s) 442).

The systems described herein can perform step 606 in a variety of ways. In one example, signal extending device 130 can store the first data stream into a replay buffer (e.g., replay buffer(s) 444A), transmit the first data stream from the replay buffer to the second plurality of data lanes in response to a replay request (e.g., a replay request from endpoint device 114), and deallocate the first data stream from the replay buffer in response to an acknowledgement response from the second plurality of data lanes, as described herein.

At step 608 one or more of the systems described herein transmit the first data stream from the first buffer to a second plurality of data lanes of the signal extension device coupled to an endpoint device. For example, signal extending device 130 can transmit the first data stream to endpoint device 114.

The systems described herein can perform step 608 in a variety of ways. In one example, the second plurality of data lanes is coupled to an endpoint device and configured to transmit data at a second data rate that is less than the first data rate. In some examples, a ratio of a number of the second plurality of data lanes to a number of the first plurality of data lanes corresponds to a ratio of the first data rate to the second data rate. In some examples, each of the first plurality of data lanes statically maps to more than one of the second plurality of data lanes based on the ratio of the first data rate to the second data rate.

At step 610 one or more of the systems described herein pass through credit information between the host device and the endpoint device. For example, signal extending device 130 can pass through credit information from endpoint device 114 to host device 112.

In some examples, steps 602-610 can correspond to a downstream transmission. In addition and/or alternatively to steps 602-610, method 600 can include receiving a second data stream from the second plurality of data lanes in the second data packet format (e.g., signal extending device 130 receiving the second data stream from endpoint device 114 for an upstream transmission), converting the received second data stream into the first data packet format (e.g., signal extending device 130 and/or a control circuit thereof converting the second data stream), storing the converted second data stream into a buffer (e.g., signal extending device 130 storing the second data stream into a buffer such as buffer(s) 442), storing the converted second data stream into a replay buffer (e.g., signal extending device 130 storing the second data stream into a replay buffer such as replay buffer(s) 444B), transmitting the converted second data stream from the buffer to the first plurality of data lanes (e.g., signal extending device 130 transmitting the second data stream to host device 112), transmitting the converted second data stream from the replay buffer to the first plurality of data lanes in response to a replay request (e.g., signal extending device 130 re-transmitting in response to a replay request from host device 112), and deallocating the converted second data stream from the replay buffer in response to an acknowledgement response from the first plurality of data lanes.

As detailed above, server systems need to scale across the growing requirements of compute, and memory bandwidth and capacity, necessitation an increase in IO performance, which has motivated the doubling of the data rate for IO buses, such as PCIe, with each generation. With each new generation, the adoption rate of the newest generation speeds across the device ecosystem can be uneven. Although a CPU can support the newest generation, plugging in a slower device to a newest generation capable root port can result in underutilizing the available bandwidth, and in turn, system performance. The systems and methods described herein provide a new class of smart retimer devices that can offer an IO aggregation solution and provide effective pin-fanout and lightweight switching capability with little design overhead. This present application provides details of how such a device can be constructed, and deployed in a system to offer a solution having advantages over a conventional switching module.

Two of the critical requirements for IO performance and scalability for server systems are IO bandwidth and IO lanes. The IO bandwidth for PCIe stack can be improved by doubling the data rate with each generation, however, there can be a practical limit to the number of lanes that a CPU system can be built with. On the other hand, the relatively slow adoption rates of newer PCIe generations (e.g., PCIe Gen 6) by the industry can result in older generation devices being used with newer generation servers (e.g., plugging in a Gen 5 device to a Gen 6 capable root port). The smart retimer provided herein can address both of the concerns by: providing a mechanism to enable a newer generation port (e.g., PCIe Gen 6 port) to achieve full line rate by reducing the link width for each connection point as described herein, and providing a mechanism to increase the effective lane count to allow plugging in a higher number of lower speed devices to a CPU without increasing CPU's Lane count, as described herein.

PCIe switches can be used to achieve a fan-out. However, the fully functional traditional switches that are available must build full decoding and routing capabilities, increasing overhead and complexity. The systems and methods described herein advantageously provide a lightweight solution that can operate within a PCIe retimer footprint. The smart retimer module described herein provides functionalities including acting as a simple x16-x16 retimer, or as a fanout switch to provide a scale-out solution. In the simple retimer mode, the design can implement a fast-path logic to ignore the functionality required for the scale-out solution.

FIG. 2 provides an overview of the scale-out function of the smart retimer module. In one example, a x8 Gen 6 smart retimer can be used to connect to 1×16, 2×8, or 4×4 Gen 5 devices to provide a pin-out solution. The smart retimer can provide a single x8 Gen 6 capable Upstream Port, and a configurable number of Gen 5 capable downstream ports. This module is not supposed to provide a fully crossbar switching or destination decoding/routing capabilities, instead, the lanes from the Host to EP devices can mapped one-to-one. For example, all x8 Gen 6 lanes may map to x16 Gen 5 lanes (see, e.g., FIG. 3A), 2×4 Gen 6 lanes may map directly to 2×8 Gen 5 lanes (see, e.g., FIG. 3B) and so on (see, e.g., FIG. 3C).

The smart retimer module can operate in Flit Mode on the Gen 6 interface (for simplicity, called as FM Port hereon) that connects with the Host and in Non-Flit Mode on the Gen 5 port (for simplicity, called as NFM Port hereon) that connect to the EP devices. Accordingly, the logic can be capable of converting the packet streams from one mode to another. The smart retimer can pack/unpack the incoming Flits and Transactions Layer Packets to perform the cross-over, as described with respect to FIGS. 4A-4B.

The systems and methods provided herein can implement enough store-and-forward capabilities to perform the conversion and meet the PCIe Gen 6 line-rate requirements. However, the smart retimer module can forego partaking in the credit-based flow control which can remain transparent to its implementation. As such, the information contained within the Flow Control Packets (DLLPs) sent from the NFM Port can be reformatted but must be passed unaltered to the FM port and vice-versa. The smart retimer module provided herein does not maintain state of any credits on its Rx (receive) interface and does not qualify sending TLPs with availability of credits on its Tx (transmit) interface.

The ‘Replay’ relationship of the smart retimer's link partners can be managed independently by its downstream and upstream ports for transmissions that convert between FM and NFM. For example, the FM port can adhere to the replay protocol at a FLIT granularity (implemented in the Phy Layer Logical sub-block module), while the NFM port can adhere to the replay protocol at a TLP granularity (implemented in the Data Link Layer module).

In the downstream direction, the smart retimer Rx side can perform bit-error correction through forward error correction (FEC) followed by cyclic redundancy check (CRC) error detection for transmissions that convert between FM and NFM. If the FLIT is invalid, the smart retimer can initiate the Flit Replay and does not unpack/store any TLP/DLLP information in its shallow buffers. In the downstream direction, the smart retimer Tx can store the TLPs in TLP Replay Buffer and can deallocate the entries only after receiving a successful acknowledgement from the link partner.

In the upstream direction, the smart retimer Rx side can detect link error conditions by regenerating and checking the link CRC (LCRC) value received for TLPs and DLLPs for transmissions that convert between FM and NFM. If the LCRC check fails for TLPs, it can ask the link partner to replay the TLP using explicit sequence number. In the upstream direction, the smart retimer Tx side can store the packed FLIT in the Flit Replay Buffer and must deallocate the entries only after receiving a successful acknowledgement from the link partner.

In other examples, such as transmissions without converting between FM and NFM (e.g., transmissions that are geared ratio changes between different data rates of host and endpoint devices), error correction schemes (e.g., FEC and/or LCRC) can be implemented directly at the host and/or endpoint devices, rather than the smart retimer. In such examples, the smart retimer can forego the replay flows described herein, including omitting the replay buffers, error detection/correction, etc., which can instead be implemented with the host and/or endpoint devices.

The smart retimer module can be connected to 8 lanes on the Host (each operating on Gen 6 speeds), and up to 16 lanes (each operating on Gen 5 or lower speeds) on the device facing interface, in one implementation. However, the smart retimer module is not expected to provide any decode/routing capability unlike a traditional PCIe fabric Switch. Instead, when operating in bifurcated mode, the device can assume static one-to-many mapping as shown in the topology diagrams described herein. The static mapping (see, e.g., FIGS. 3A-3C) can be applied when the bifurcation is enabled.

The Smart Retimer module's Upstream and Downstream ports can be hidden and does not partake during the PCIe bus enumeration process. All configuration accesses during the bus scan can be passed as is using the static lane-to-lane mapping described herein (see, e.g., FIGS. 3A-3C). This allows for the system software to not burn Bus #while discovering the PCIe bus characteristics, unlike a switch that supports full decoding and routing capabilities. Like existing retimer devices, in some implementations, the smart retimer module can allow for out-of-band accesses to configure and setup the device prior to the link-up. In some implementations, the smart retimer module can also provide an out-of-band interface for runtime telemetry and error harvesting information.

One advantage of the solution provided herein is allowing a scale-out solution, while utilizing full link bandwidth as described herein. Along with the end customers such as Cloud Service Providers and OEM partners, the systems and methods provided herein can also help PCIe retimer vendors build a competitive product to bridge the chasm between availability of Gen N bandwidth on the Host CPUs versus industry adoption by the Gen N devices. Although some of the examples described herein reference a PCIe Gen 6 timeframe, the systems and methods described herein can apply to every generation leap hereon. Noting that building a full-fledged switch can an expensive undertaking, the systems and methods described herein offer a solution with pared down complexity.

In some aspects, the techniques described herein relate to a signal extension device including: a first plurality of data lanes configured to transmit data at a first data rate; a second plurality of data lanes configured to transmit data at a second data rate that is less than the first data rate; and a control circuit configured to retransmit data received from one of the first plurality of data lanes and the second plurality of data lanes to another of the first plurality of data lanes and the second plurality of data lanes based on a static mapping of lanes between the first plurality of data lanes and the second plurality of data lanes.

In some aspects, the techniques described herein relate to a device, wherein a ratio of a number of the second plurality of data lanes to a number of the first plurality of data lanes corresponds to a ratio of the first data rate to the second data rate.

In some aspects, the techniques described herein relate to a device, wherein each of the first plurality of data lanes statically maps to more than one of the second plurality of data lanes based on the ratio of the first data rate to the second data rate.

In some aspects, the techniques described herein relate to a device, further configured to pass through credit information for a transmit flow control without updating the credit information.

In some aspects, the techniques described herein relate to a device, wherein for a downstream transmission from the first plurality of data lanes to the second plurality of data lanes, the control circuit is configured to: receive a data stream from the first plurality of data lanes in a first data packet format; convert the received data stream into a second data packet format; store the converted data stream into a buffer; and transmit the converted data stream from the buffer to the second plurality of data lanes.

In some aspects, the techniques described herein relate to a device, wherein for the downstream transmission, the control circuit is further configured to: store the converted data stream into a replay buffer; transmit the converted data stream from the replay buffer to the second plurality of data lanes in response to a replay request; and deallocate the converted data stream from the replay buffer in response to an acknowledgement response from the second plurality of data lanes.

In some aspects, the techniques described herein relate to a device, wherein for the downstream transmission, the control circuit is further configured to: detect an error in the received data stream; and discard the received data stream in response to detecting the error.

In some aspects, the techniques described herein relate to a device, wherein for an upstream transmission from the second plurality of data lanes to the first plurality of data lanes, the control circuit is configured to: receive a data stream from the second plurality of data lanes in a second data packet format; store the received data stream into a buffer; convert the stored data stream into a first data packet format; and transmit the converted data stream from the buffer to the first plurality of data lanes.

In some aspects, the techniques described herein relate to a device, wherein for the upstream transmission, the control circuit is further configured to: store the converted data stream into a replay buffer; transmit the converted data stream from the replay buffer to the first plurality of data lanes in response to a replay request; and deallocate the converted data stream from the replay buffer in response to an acknowledgement response from the first plurality of data lanes.

In some aspects, the techniques described herein relate to a device, wherein for the upstream transmission, the control circuit is further configured to: detect an error in the received data stream; and discard the received data stream in response to detecting the error.

In some aspects, the techniques described herein relate to a system including: a memory; a processor coupled to the memory and configured to transmit data at a first data rate; an endpoint device configured to transmit data at a second data rate that is less than the first data rate; a signal extension device configured to transmit data between the processor and the endpoint device and pass through credit information between the processor and the endpoint device, the signal extension device including: a first plurality of data lanes coupled to the processor and configured to transmit data at the first data rate; a second plurality of data lanes coupled to the endpoint device and configured to transmit data at the second data rate; and a control circuit configured to retransmit data between the first plurality of data lanes and the second plurality of data lanes based on a static mapping between the first plurality of data lanes and the second plurality of data lanes.

In some aspects, the techniques described herein relate to a system, wherein: a ratio of a number of the second plurality of data lanes to a number of the first plurality of data lanes corresponds to a ratio of the first data rate to the second data rate; and each of the first plurality of data lanes statically maps to more than one of the second plurality of data lanes based on the ratio of the first data rate to the second data rate.

In some aspects, the techniques described herein relate to a system, wherein for a downstream transmission from the first plurality of data lanes to the second plurality of data lanes, the control circuit is configured to: receive a data stream from the first plurality of data lanes in a first data packet format; convert the received data stream into a second data packet format; store the converted data stream into a buffer; store the converted data stream into a replay buffer; transmit the converted data stream from the buffer to the second plurality of data lanes; transmit the converted data stream from the replay buffer to the second plurality of data lanes in response to a replay request; and deallocate the converted data stream from the replay buffer in response to an acknowledgement response from the second plurality of data lanes.

In some aspects, the techniques described herein relate to a system, wherein for the downstream transmission, the control circuit is further configured to: detect an error in the received data stream; and discard the received data stream in response to detecting the error.

In some aspects, the techniques described herein relate to a system, wherein for an upstream transmission from the second plurality of data lanes to the first plurality of data lanes, the control circuit is configured to: receive a data stream from the second plurality of data lanes in a second data packet format; store the received data stream into a buffer; convert the stored data stream into a first data packet format; store the converted data stream into a replay buffer; transmit the converted data stream from the buffer to the first plurality of data lanes; transmit the converted data stream from the replay buffer to the first plurality of data lanes in response to a replay request; and deallocate the converted data stream from the replay buffer in response to an acknowledgement response from the first plurality of data lanes.

In some aspects, the techniques described herein relate to a system, wherein for the upstream transmission, the control circuit is further configured to: detect an error in the received data stream; and discard the received data stream in response to detecting the error.

In some aspects, the techniques described herein relate to a method including: receiving, from a first plurality of data lanes of a signal extension device coupled to a host device, a first data stream in a first data packet format; converting, by a control circuit, the received first data stream into a second data packet format; storing the converted first data stream into a first buffer; transmitting the converted first data stream from the first buffer to a second plurality of data lanes of the signal extension device coupled to an endpoint device; and passing through credit information between the host device and the endpoint device; wherein the first plurality of data lanes is coupled to a host device and configured to transmit data at a first data rate; and the second plurality of data lanes is coupled to an endpoint device and configured to transmit data at a second data rate that is less than the first data rate.

In some aspects, the techniques described herein relate to a method, wherein: a ratio of a number of the second plurality of data lanes to a number of the first plurality of data lanes corresponds to a ratio of the first data rate to the second data rate; and each of the first plurality of data lanes statically maps to more than one of the second plurality of data lanes based on the ratio of the first data rate to the second data rate.

In some aspects, the techniques described herein relate to a method, further including: storing the converted first data stream into a replay buffer; transmitting the converted first data stream from the replay buffer to the second plurality of data lanes in response to a replay request; and deallocating the converted first data stream from the replay buffer in response to an acknowledgement response from the second plurality of data lanes.

In some aspects, the techniques described herein relate to a method, further including: receiving a second data stream from the second plurality of data lanes in the second data packet format; converting the second data stream into the first data packet format; storing the converted second data stream into a buffer; storing the converted second data stream into a replay buffer; transmitting the converted second data stream from the buffer to the first plurality of data lanes; transmitting the converted second data stream from the replay buffer to the first plurality of data lanes in response to a replay request; and deallocating the converted second data stream from the replay buffer in response to an acknowledgement response from the first plurality of data lanes.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In addition, one or more of the instructions and/or corresponding circuits described herein transforms data, physical devices, and/or representations of physical devices from one form to another. For example, one or more of the instructions/circuits recited herein receives data to be transformed, transforms the data into an appropriate packet format, outputs a result of the transformation to transmit the data, uses the result of the transformation to confirm data transmission, and stores the result of the transformation to complete data transmission. Additionally, or alternatively, one or more of the instructions recited herein can transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A signal extension device comprising:
a first plurality of data lanes configured to transmit data at a first data rate;
a second plurality of data lanes configured to transmit data at a second data rate that is less than the first data rate; and
a control circuit configured to retransmit data received from one of the first plurality of data lanes and the second plurality of data lanes to another of the first plurality of data lanes and the second plurality of data lanes based on a static mapping of lanes between the first plurality of data lanes and the second plurality of data lanes.

2. The device of claim 1, wherein a ratio of a number of the second plurality of data lanes to a number of the first plurality of data lanes corresponds to a ratio of the first data rate to the second data rate.

3. The device of claim 2, wherein each of the first plurality of data lanes statically maps to more than one of the second plurality of data lanes based on the ratio of the first data rate to the second data rate.

4. The device of claim 1, further configured to pass through credit information for a transmit flow control without updating the credit information.

5. The device of claim 1, wherein for a downstream transmission from the first plurality of data lanes to the second plurality of data lanes, the control circuit is configured to:
receive a data stream from the first plurality of data lanes in a first data packet format;
convert the received data stream into a second data packet format;
store the converted data stream into a buffer; and
transmit the converted data stream from the buffer to the second plurality of data lanes.

6. The device of claim 5, wherein for the downstream transmission, the control circuit is further configured to:
store the converted data stream into a replay buffer;
transmit the converted data stream from the replay buffer to the second plurality of data lanes in response to a replay request; and
deallocate the converted data stream from the replay buffer in response to an acknowledgement response from the second plurality of data lanes.

7. The device of claim 5, wherein for the downstream transmission, the control circuit is further configured to:
detect an error in the received data stream; and
discard the received data stream in response to detecting the error.

8. The device of claim 1, wherein for an upstream transmission from the second plurality of data lanes to the first plurality of data lanes, the control circuit is configured to:
receive a data stream from the second plurality of data lanes in a second data packet format;
store the received data stream into a buffer;
convert the stored data stream into a first data packet format; and
transmit the converted data stream from the buffer to the first plurality of data lanes.

9. The device of claim 8, wherein for the upstream transmission, the control circuit is further configured to:
store the converted data stream into a replay buffer;
transmit the converted data stream from the replay buffer to the first plurality of data lanes in response to a replay request; and
deallocate the converted data stream from the replay buffer in response to an acknowledgement response from the first plurality of data lanes.

10. The device of claim 8, wherein for the upstream transmission, the control circuit is further configured to:
detect an error in the received data stream; and
discard the received data stream in response to detecting the error.

11. A system comprising:
a memory;
a processor coupled to the memory and configured to transmit data at a first data rate;
an endpoint device configured to transmit data at a second data rate that is less than the first data rate;
a signal extension device configured to transmit data between the processor and the endpoint device and pass through credit information between the processor and the endpoint device, the signal extension device comprising:
a first plurality of data lanes coupled to the processor and configured to transmit data at the first data rate;
a second plurality of data lanes coupled to the endpoint device and configured to transmit data at the second data rate; and
a control circuit configured to retransmit data between the first plurality of data lanes and the second plurality of data lanes based on a static mapping between the first plurality of data lanes and the second plurality of data lanes.

12. The system of claim 11, wherein:
a ratio of a number of the second plurality of data lanes to a number of the first plurality of data lanes corresponds to a ratio of the first data rate to the second data rate; and
each of the first plurality of data lanes statically maps to more than one of the second plurality of data lanes based on the ratio of the first data rate to the second data rate.

13. The system of claim 11, wherein for a downstream transmission from the first plurality of data lanes to the second plurality of data lanes, the control circuit is configured to:
receive a data stream from the first plurality of data lanes in a first data packet format;
convert the received data stream into a second data packet format;
store the converted data stream into a buffer;
store the converted data stream into a replay buffer;
transmit the converted data stream from the buffer to the second plurality of data lanes;
transmit the converted data stream from the replay buffer to the second plurality of data lanes in response to a replay request; and
deallocate the converted data stream from the replay buffer in response to an acknowledgement response from the second plurality of data lanes.

14. The system of claim 13, wherein for the downstream transmission, the control circuit is further configured to:
detect an error in the received data stream; and
discard the received data stream in response to detecting the error.

15. The system of claim 11, wherein for an upstream transmission from the second plurality of data lanes to the first plurality of data lanes, the control circuit is configured to:
receive a data stream from the second plurality of data lanes in a second data packet format;
store the received data stream into a buffer;
convert the stored data stream into a first data packet format;
store the converted data stream into a replay buffer;
transmit the converted data stream from the buffer to the first plurality of data lanes;
transmit the converted data stream from the replay buffer to the first plurality of data lanes in response to a replay request; and
deallocate the converted data stream from the replay buffer in response to an acknowledgement response from the first plurality of data lanes.

16. The system of claim 15, wherein for the upstream transmission, the control circuit is further configured to:
detect an error in the received data stream; and
discard the received data stream in response to detecting the error.

17. A method comprising:
receiving, from a first plurality of data lanes of a signal extension device coupled to a host device, a first data stream in a first data packet format;
converting, by a control circuit, the received first data stream into a second data packet format;
storing the converted first data stream into a first buffer;
transmitting the converted first data stream from the first buffer to a second plurality of data lanes of the signal extension device coupled to an endpoint device; and
passing through credit information between the host device and the endpoint device;
wherein the first plurality of data lanes is coupled to a host device and configured to transmit data at a first data rate; and
the second plurality of data lanes is coupled to an endpoint device and configured to transmit data at a second data rate that is less than the first data rate.

18. The method of claim 17, wherein:
a ratio of a number of the second plurality of data lanes to a number of the first plurality of data lanes corresponds to a ratio of the first data rate to the second data rate; and
each of the first plurality of data lanes statically maps to more than one of the second plurality of data lanes based on the ratio of the first data rate to the second data rate.

19. The method of claim 17, further comprising:
storing the converted first data stream into a replay buffer;
transmitting the converted first data stream from the replay buffer to the second plurality of data lanes in response to a replay request; and
deallocating the converted first data stream from the replay buffer in response to an acknowledgement response from the second plurality of data lanes.

20. The method of claim 17, further comprising:
receiving a second data stream from the second plurality of data lanes in the second data packet format;
converting the second data stream into the first data packet format;
storing the converted second data stream into a buffer;
storing the converted second data stream into a replay buffer;
transmitting the converted second data stream from the buffer to the first plurality of data lanes;
transmitting the converted second data stream from the replay buffer to the first plurality of data lanes in response to a replay request; and
deallocating the converted second data stream from the replay buffer in response to an acknowledgement response from the first plurality of data lanes.
